(19) United States
(12) Patent Application Publication
(10) Pub. No.: US 2026/0290704 A1
(43) Pub. Date: Sep. 24, 2026

(54) MULTILAYER ELECTRONIC DEVICE

(71) Applicant: TDK Corporation, Tokyo (JP)

(72) Inventors: Makoto ISHIZAKI, Tokyo (JP); Masahide ISHIZUYA, Tokyo (JP); Toshio SAKURAI, Tokyo (JP); Asuka MURAKAMI, Tokyo (JP); Noriyuki INOUE, Tokyo (JP); Yuki OKAFUJI, Tokyo (JP)

(73) Assignee: TDK Corporation, Tokyo (JP)

(21) Appl. No.: 19/570,365

(22) Filed: Mar. 18, 2026

(30) Foreign Application Priority Data
Mar. 21, 2025 (JP) 2025-047256

(51) Int. Cl. H01G 4/30; H01G 4/012

(52) U.S. Cl. CPC H01G 4/30; H01G 4/012

(57) ABSTRACT

A multilayer electronic device includes an element body and insulating layers. The element body includes an interior region including inner dielectric layers and internal electrode layers, which are alternately laminated along a direction of a third axis, and exterior regions disposed at both sides outward from the interior region in the direction of the third axis. The insulating layers are provided on respective side surfaces of the element body. The interior region includes a central region and an end region in a predetermined section of the element body cut parallel to a first axis and the third axis. At least one of the internal electrode layers included in the end region has a width along a direction of the first axis smaller by 1 μm or more than an average width of the internal electrode layers included in the central region, in the predetermined section.

### TECHNICAL FIELD

The present invention relates to a multilayer electronic device and a method of manufacturing the same.

Demand for downsizing electronic devices has been increasing along with a recent increase in the density of electronic circuits included in digital electronics (e.g., mobile phones). Constituent multilayer electronic devices of these circuits have rapidly been reduced in size and increased in capacity.

Patent Document I discloses a method of manufacturing a multilayer ceramic capacitor. The method includes a step of printing internal electrodes continuing in a longitudinal direction in strips on molded continuous dielectric sheets, a step of continuously laminating the dielectric sheets with the printed internal electrodes and continuous dielectric sheets without printed internal electrodes, a step of cutting the resultant continuous laminate into pieces and then forming insulating layers at portions where no external electrodes are to be provided among exposed portions of the internal electrodes, and a step of forming external electrodes at the exposed portions of the internal electrodes.

It is certain that the multilayer ceramic capacitor disclosed in Patent Document 1 is effective in covering the side exposed internal electrodes with the insulating layers; however, should an element body be deformed by compression, thermal shrinkage, or the like, it tends to be difficult to ensure insulation between layers of the internal electrodes near a side surface of the element body. In particular, in a situation where the number of the internal electrodes is increased to reduce distances between the internal electrodes along the lamination direction, a corner portion or the like of a relatively severely deformed element body may have a short circuit between adjacent internal electrodes.
Patent Document 1: JP Patent Application Laid Open No. S62-237714

### SUMMARY

The present invention has been achieved in view of the above circumstances and aims to prevent a short circuit between internal electrode layers.

To achieve the above object, a multilayer electronic device according to the present disclosure is as follows.

The multilayer electronic device includes
an element body including
an interior region including inner dielectric layers and internal electrode layers, the inner dielectric layers and the internal electrode layers being alternately laminated along a direction of a third axis and being substantially parallel to a plane containing a first axis and a second axis, and
exterior regions disposed at both sides outward from the interior region in the direction of the third axis;
insulating layers provided on respective side surfaces of the element body, the side surfaces facing each other in a direction of the first axis; and
external electrodes provided on respective end surfaces of the element body and electrically connected to the internal electrode layers, the end surfaces facing each other in a direction of the second axis,
wherein
the interior region includes a central region and an end region in a predetermined section of the element body cut parallel to the first axis and the third axis;
the central region contains a center of the interior region in the direction of the third axis;
the end region contains an end of the interior region in the direction of the third axis;
distances between the internal electrode layers included in the central region and the insulating layers have a 1-μm variation at most in the predetermined section; and
at least one of the internal electrode layers included in the end region has a width along the direction of the first axis smaller by 1 μm or more than an average width of the internal electrode layers included in the central region, in the predetermined section.

According to such a multilayer electronic device, the internal electrode layer included in the end region of the interior region is shorter, along the first axis direction, than the internal electrode layers included in the central region. In the region of the element body relatively prone to have deformation due to pressure or thermal shrinkage, the internal electrode layer is removed or accounts for a smaller proportion. Thus, according to such a multilayer electronic device, a short circuit between the internal electrode layers in the vicinity of the side surfaces opposing the insulating layers can be appropriately prevented despite deformation of the multilayer electronic device.

Examples of specific forms of the above include the following.

It may be that, for example, in the predetermined section, the internal electrode layers included in the end region have a width, along the direction of the first axis, smaller by 0 to 20 μm than the average width of the internal electrode layers included in the central region.

It may be that, for example, in the predetermined section,
the internal electrode layers included in the end region include an outermost internal electrode layer and an end region internal electrode layer;
the internal electrode layers included in the central region include central region internal electrode layers;
the outermost internal electrode layer is closest to the end in the direction of the third axis;
the end region internal electrode layer is at a distance of 10% or less of an entire length of the element body in the direction of the third axis from the outermost internal electrode layer toward the center; and
the outermost internal electrode layer and the end region internal electrode layer have a width, along the direction of the first axis, smaller by 1 μm or more than an average width of the central region internal electrode layers.

It may be that, for example,
the internal electrode layers included in the end region include electrode layer ends in the direction of the first axis; and
the multilayer electronic device further includes a filler filling a space between the electrode layer ends and the insulating layers.

It may be that, for example, 90% or more of a composition of the filler in mole percent matches a composition of the insulating layers or the inner dielectric layers.

It may be that, for example, 20% or more of the composition of the filler in mole percent differs from the composition of the insulating layers or the inner dielectric layers.

It may be that, for example, the filler contains at least one selected from the group consisting of Mg, Si, and Mn; and a content of the at least one selected from the group consisting of Mg, Si, and Mn is higher by 0.01 to 3 mol % than that of the inner dielectric layers.

It may be that, for example,
the filler contains at least one selected from the group consisting of Mg, Si, and Mn; and
the filler contains an oxide of a metal identical to a metal contained in the internal electrode layers.

A method of manufacturing a multilayer electronic device, according to the present disclosure includes
laminating and then cutting inner dielectric green sheets and internal electrode pattern layers between exterior body green sheets in pairs to provide a green laminate including a green interior region where the inner dielectric green sheets and the internal electrode pattern layers are alternately laminated between green exterior regions defined by the exterior body green sheets in pairs;
irradiating a laminate side surface of the green laminate with a laser for laser processing of the green interior region, the laminate side surface including at least one cut surface of the green laminate; and
firing the green laminate after the laser processing,
wherein
the laser processing of the green interior region is performed so that the internal electrode pattern layers included in an end region of the green interior region are smaller along a normal direction of the laminate side surface than the internal electrode pattern layers included in a central region of the green interior region,
the end region contains an end of the green interior region in the lamination direction, and the central region contains a center of the green interior region in the lamination direction.

According to such a method of manufacturing a multilayer electronic device, the internal electrode pattern layers included in the end region of the green interior region are shorter along the normal direction of the laminate side surface than the internal electrode pattern layers included in the central region. In the region relatively prone to have deformation due to thermal shrinkage during a subsequent step (e.g., a firing step), the internal electrode layers are removed or account for a smaller proportion. Thus, according to such a method of manufacturing a multilayer electronic device, a short circuit between the internal electrode pattern layers can be appropriately prevented despite deformation of an end or the like of the green laminate during the firing step or the like.

### BRIEF DESCRIPTION OF THE DRAWING(S)

FIG. 1 is a schematic sectional view of a multilayer ceramic capacitor, which is a multilayer electronic device, according to one embodiment of the present disclosure.

FIG. 2 is a schematic perspective view of an element body and insulating layers of the multilayer ceramic capacitor illustrated in FIG. 1.

FIG. 3 is a schematic sectional view along a line III-III in FIG. 2.

FIG. 4 is a schematic sectional view of a ceramic capacitor according to a first modified example.

FIG. 5 is a schematic sectional view of a ceramic capacitor according to a second modified example.

FIG. 6 is a perspective view of a first green chip according to a first stage of a manufacturing process.

FIG. 7 is a perspective view of a second green chip according to a second stage of the manufacturing process.

FIG. 8A-8B is a schematic view illustrative of behaviors of ends of internal electrode layers under deformation.

### DETAILED DESCRIPTION

Detailed description is provided based on the present embodiment with reference to the drawings; however, the present disclosure is not construed as limited only to the following embodiment.

Constituents described below include those that a person skilled in the art can easily conceive of or those that are substantially the same. Furthermore, the constituents described below can be recombined appropriately.

Hereinafter, the present disclosure is described based on the embodiment illustrated in the drawings.

As one embodiment of a multilayer electronic device according to the present disclosure, an overall configuration of a multilayer ceramic capacitor 10 is described.

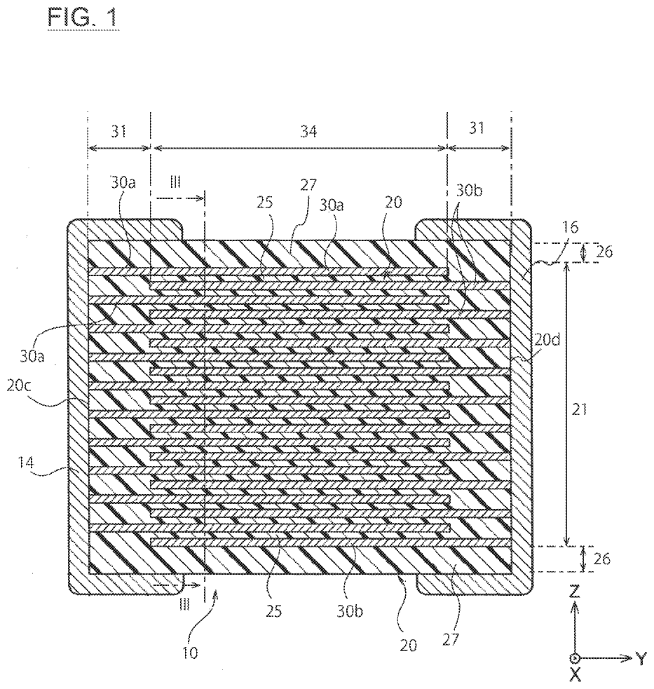

FIG. 1 is a schematic sectional view of the multilayer ceramic capacitor 10 according to the present embodiment. As illustrated in FIG. 1, the multilayer ceramic capacitor 10 includes an element body 20 including an interior region 21 and exterior regions 26.

The interior region 21 includes inner dielectric layers 25 and internal electrode layers 30, which are substantially parallel to a plane containing the X-axis as a first axis and the Y-axis as a second axis and are alternately laminated along the direction of the Z-axis as a third axis. The exterior regions 26 are disposed at both sides outward from the interior region in the Z-axis direction (third axis direction). The exterior regions 26 include outer dielectric layers 27.

In this context, “substantially parallel” means that the internal electrode layers 30 and the inner dielectric layers 25 are mostly parallel to the plane but may partly be slightly nonparallel. This intends to convey that the internal electrode layers 30 and the inner dielectric layers 25 may be slightly uneven or inclined.

As illustrated in FIG. 1, end surfaces 20c and 20d of the element body 20 in pairs, which face each other in the second axis (Y-axis) direction, are provided with external electrodes 14 and 16, which electrically connect to the internal electrode layers 30, respectively. That is, the internal electrode layers 30 include first internal electrode layers 30a, which connect to the external electrode 14 on the end surface 20c, and second internal electrode layers 30b, which connect to the external electrode 16 on the end surface 20d. The first internal electrode layers 30a and the second internal electrode layers 30b are alternately laminated along the third axis (Z-axis), with the inner dielectric layers 25 in between.

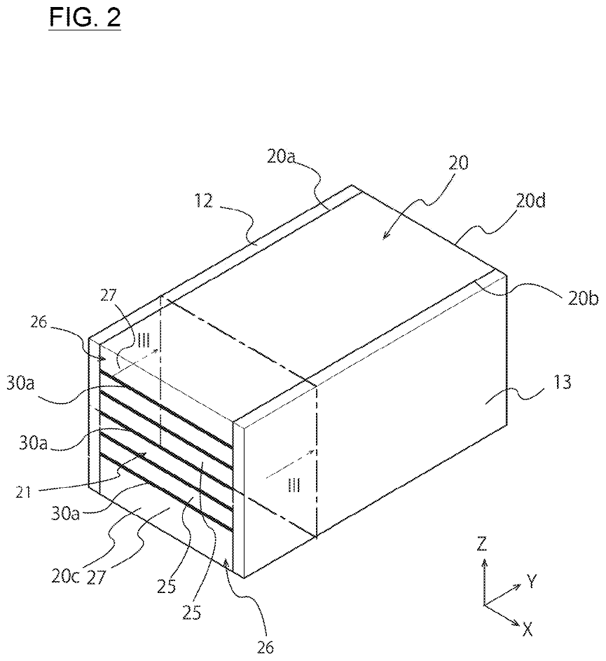

FIG. 2 is a schematic perspective view of the element body 20 and insulating layers 12 and 13 of the multilayer ceramic capacitor 10 illustrated in FIG. 1. FIG. 2 does not illustrate the external electrodes 14 and 16 (see FIG. 1) of the multilayer ceramic capacitor 10 in order to illustrate the end surface 20c of the element body 20. Note that, in FIGS. 1 and 2, the internal electrode layers 30 are illustrated to have a larger thickness (dimension in the Z-axis direction) than the actual dimension, and the internal electrode layers 30 and the inner dielectric layers 25 are simply and schematically illustrated to be fewer in number. The numbers of the internal electrode layers 30 and the inner dielectric layers 25 and the thickness of the internal electrode layers 30 are not limited.

As illustrated in FIG. 2, side surfaces 20a and 20b of the element body 20 in pairs, which face each other in the first axis (X-axis) direction, are provided with the insulating layers 12 and 13, respectively. The side surface 20a in the negative direction of the X-axis is provided with the insulating layer 12. The side surface 20b in the positive direction of the X-axis is provided with the insulating layer 13.

As illustrated in FIG. 1, the internal electrode layers 30 include an internal electrode overlapping portion 34 and internal electrode lead-out portions 31. The internal electrode overlapping portion 34 is where the first internal electrode layers 30a, which connect to the external electrode 14 on the end surface 20c of the pair of end surfaces 20c and 20d, and the second internal electrode layers 30b, which connect to the external electrode 16 on the end surface 20d of the pair, overlap when viewed from the Z-axis direction (third axis direction). The internal electrode lead-out portions 31 are where the first internal electrode layers 30a and the second internal electrode layers 30b do not overlap when viewed from the Z-axis direction (third axis direction).

As illustrated in FIG. 1, in the element body 20, the internal electrode overlapping portion 34 is disposed so as to be interposed between the internal electrode lead-out portions 31 in pairs from both sides in the Y-axis (second axis) direction. In other words, from the end surface 20c to the end surface 20d of the element body 20 along the second axis (Y-axis) direction, the internal electrode lead-out portion 31, the internal electrode overlapping portion 34, and the internal electrode lead-out portion 31 are disposed in sequence. The internal electrode lead-out portion 31 close to the end surface 20c is part of the first internal electrode layers 30a. The internal electrode lead-out portion 31 close to the end surface 20d is part of the second internal electrode layers 30b. The internal electrode overlapping portion 34 includes other part of the first internal electrode layers 30a and other part of the second internal electrode layers 30b.

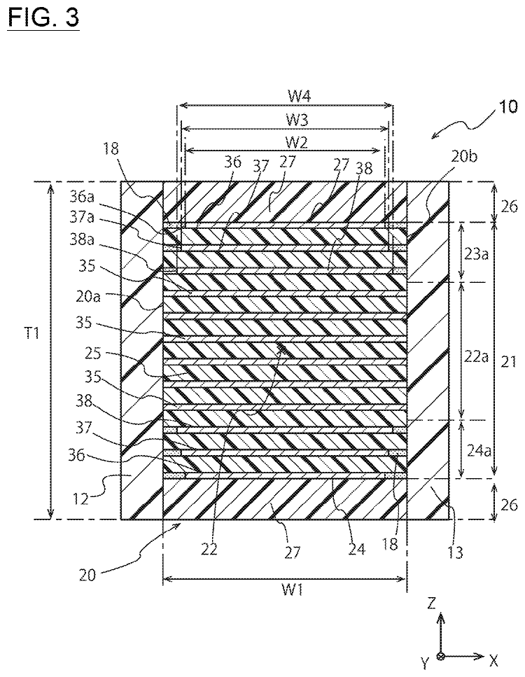

FIG. 3 is a sectional view along a line III-III in FIG. 2. That is, FIG. 3 is a sectional view of the element body 20 and the insulating layers 12 and 13 in a predetermined section of the element body 20 cut in parallel to the first axis (X-axis) and the third axis (Z-axis). As illustrated in FIG. 3, the interior region 21 of the element body 20 includes a central region 22a and end regions 23a and 24a. The central region 22a contains a center 22 of the interior region 21 in the third axis (Z-axis) direction. The end regions 23a and 24a contain ends 23 and 24 of the interior region 21 in the third axis (Z-axis) direction.

As illustrated in FIG. 3, the central region 22a includes internal electrode layers 35. The internal electrode layers 35 included in the central region 22a have a substantially constant width W1 along the first axis (X-axis) direction. Thus, distances between ends, in the negative direction of the X-axis, of the internal electrode layers 35 included in the central region 22a and the insulating layer 12, which extends substantially parallel to the Z-axis direction, have a 1-μm variation at most. Distances between ends, in the positive direction of the X-axis, of the internal electrode layers 35 included in the central region 22a and the insulating layer 13, which extends substantially parallel to the Z-axis direction, have a 1-μm variation at most. The variation in the distances between the internal electrode layers 35 and the insulating layers 13 and 12 is defined by the difference found by subtracting a minimum distance value from a maximum distance value.

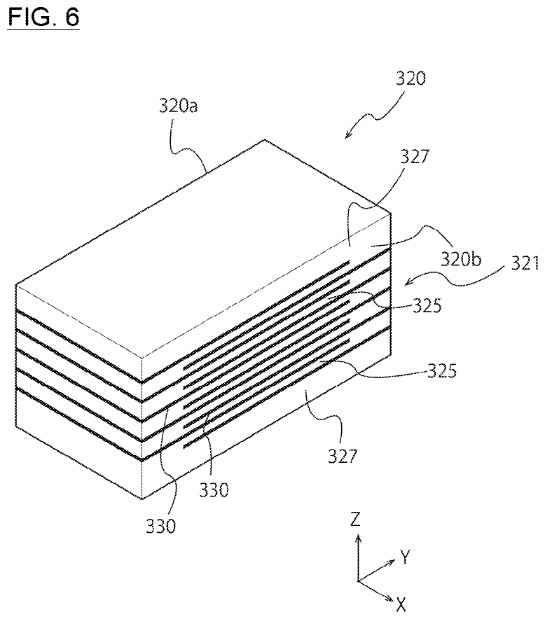

As described later, in the side surfaces 20a and 20b of the element body 20, the central region 22a can be prepared by providing unprocessed cut surfaces of a green laminate before being fired (see FIG. 6) with insulating material layers 412, which become the insulating layers 12 and 13. This enables, in the central region 22a, the variation in the distances between the internal electrode layers 35 and the insulating layers 12 and 13 to be 1 μm or less.

In contrast, as illustrated in FIG. 3, in the end region 23a in the positive direction of the Z-axis, at least one of widths W2 to W4, along the first axis (X-axis) direction, of internal electrode layers 36, 37, and 38 included in the end region 23a is smaller by 1 μm or more than the average value of the width W1, along the first axis (X-axis) direction, of the internal electrode layers 35 included in the central region 22a. The same of the end region 23a in the positive direction of the Z-axis applies to the end region 24a in the negative direction of the Z-axis.

At least either of the end regions 23a and 24a, illustrated in FIG. 3, of the multilayer ceramic capacitor 10 includes at least one of the internal electrode layers 36, 37, and 38 with the widths W2 to W4, along the first axis (X-axis) direction, smaller by 1 μm or more than the average value of the width, along the first axis (X-axis) direction, of the internal electrode layers 35 included in the central region 22a. However, in terms of effectively preventing a short circuit, preferred is that both the end region 23a in the positive direction of the Z-axis and the end region 24a in the negative direction of the Z-axis include the internal electrode layers 36, 37, and 38 with the widths W2 to W4, along the X-axis direction, smaller than the width of the internal electrode layers 35 included in the central region 22a.

As illustrated in FIG. 3, the end region 23a of the multilayer ceramic capacitor 10 includes the three internal electrode layers 36, 37, and 38. The internal electrode layer 36 is an outermost internal electrode layer closest to the end 23 in the third axis (Z-axis) direction among the internal electrode layers included in the end region 23a. The internal electrode layer 37 is an end region internal electrode layer at a distance of 10% or less of an entire length TI of the element body 20 in the third axis (Z-axis) direction from the internal electrode layer 36 (outermost internal electrode layer) toward the center 22.

The internal electrode layer 36 (outermost internal electrode layer) and the internal electrode layer 37 (end region internal electrode layer) have the widths along the first axis direction (W2 of the internal electrode layer 36 and W3 of the internal electrode layer 37) preferably smaller by 1 μm or more than the average value of the width of central region internal electrode layers (W1 of the internal electrode layers 35), which are the internal electrode layers included in the central region 22a. The outermost internal electrode layer and the end region internal electrode layer are disposed near the end 23. The side surfaces 20a and 20b in the vicinity of ends of these internal electrode layers 36 and 37 in the X-axis direction are prone to have deformation in a compression step or a firing step. Thus, reducing the widths of these internal electrode layers 36 and 37 along the first axis direction can effectively prevent a short circuit.

The internal electrode layer 38 is away, toward the center 22, from the internal electrode layer 36 (outermost internal electrode layer) by more than 10% of the entire length Tl of the element body 20. However, the width W4 of the internal electrode layer 38 along the first axis direction is smaller than the average value of the width W1, along the first axis direction, of the internal electrode layers 35 included in the central region 22a. As illustrated in FIG. 3, preferred is that, in the predetermined section, the widths W2, W3, and W4, along the first axis direction, of the internal electrode layers 36, 37, and 38 included in the end region 23a are smaller by 0 to 20 μm than the average value of the width W1, along the first axis direction, of the internal electrode layers 35 included in the central region 22a.

This is because all the internal electrode layers 36, 37, and 38 included in the end region 23a can thereby mitigate or be prevented from exposure to the side surfaces 20a and 20b, where deformation easily occurs in the compression step or the firing step. However, some internal electrode layers included in the end region 23a may be longer than the average value of the width W1, along the first axis direction, of the internal electrode layers 35 included in the central region 22a.

As illustrated in FIG. 3, the end region 24a in the negative direction of the Z-axis also includes three internal electrode layers 36, 37, and 38 similarly to the end region 23a. The internal electrode layers 36, 37, and 38 included in the end region 24a have characteristics similar to those of the internal electrode layers 36, 37, and 38 included in the end region 23a. Therefore, a detailed description of the end region 24a is omitted.

The multilayer ceramic capacitor 10 includes the predetermined section such as that illustrated in FIG. 3 at any Y-axial location. The Y-axial location of the predetermined section is not limited. However, in the multilayer ceramic capacitor 10, the internal electrode overlapping portion 34 illustrated in FIG. 1 may include the predetermined section such as that illustrated in FIG. 3; or at least three portions, namely the internal electrode overlapping portion 34 and the two internal electrode lead-out portions 31 illustrated in FIG. 1, may include the predetermined section such as that illustrated in FIG. 3. Alternatively, the multilayer ceramic capacitor 10 may have the difference in the widths of the internal electrode layers 30 illustrated in FIG. 3 in any cut sections at any Y-axial locations.

As illustrated in FIG. 3, in the multilayer ceramic capacitor 10, the widths W2, W3, and W4, along the first axis direction, of the internal electrode layers 36, 37, and 38 included in the end regions 23a and 24a satisfy W2<W3<W4, becoming smaller toward the ends 23 and 24 of the interior region 21. Reducing the widths of the internal electrode layers 36, 37, and 38 along the first axis direction step-by-step or gradually can mitigate or prevent exposure of the internal electrode layers 36, 37, and 38 to the side surfaces 20a and 20b in the vicinity of the ends where severe deformation easily occurs, effectively preventing a short circuit. Also, because severe deformation less easily occurs at a location away from the ends 23 and 24 of the interior region 21, increasing the width of the internal electrode layers along the first axis direction in such a portion can efficiently ensure electrical properties (e.g., electrical capacity).

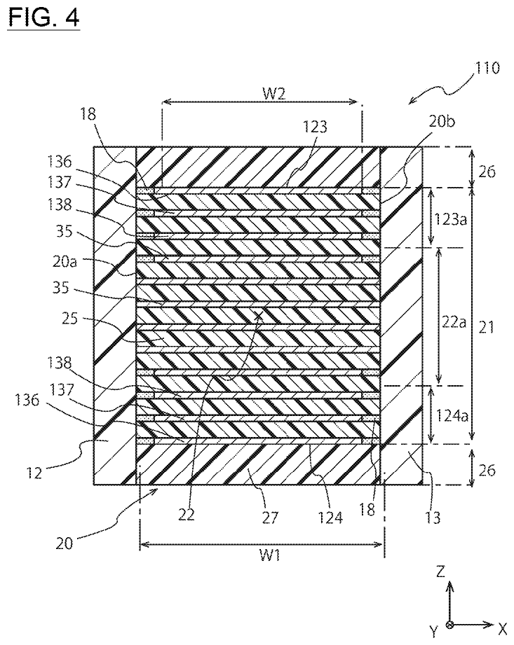

However, in the multilayer ceramic capacitor 10, the widths, along the first axis direction, of the internal electrode layers 36, 37, and 38 included in the end region 24a may be substantially constant. FIG. 4 is a sectional view of a multilayer ceramic capacitor 110 according to a first modified example, illustrating an element body 20 and insulating layers 12 and 13 in a predetermined section of the element body 20 cut in parallel to the first axis (X-axis) and the third axis (Z-axis). The multilayer ceramic capacitor 110 is similar to the multilayer ceramic capacitor 10 illustrated in the embodiment except that internal electrode layers 136, 137, and 138 included in end regions 123a and 124a containing ends 123 and 124 have a substantially constant width W2 along the first axis (X-axis) direction.

In the multilayer ceramic capacitor 110 illustrated in FIG. 4 as well, the width W2, along the first axis direction, of the internal electrode layers 136, 137, and 138 included in the end regions 123a and 124a is smaller by 1 μm or more than the average value of the width W1, along the first axis (X-axis) direction, of internal electrode layers 35 included in a central region 22a. What is common to the multilayer ceramic capacitors 110 and 10 exhibits similar effects brought by the multilayer ceramic capacitor 10.

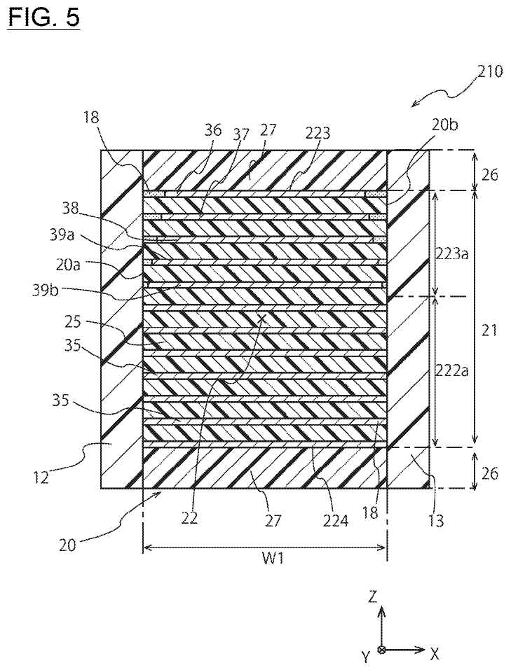

In the multilayer ceramic capacitors 10 and 110 illustrated in FIGS. 3 and 4, the difference from the internal electrode layers 35 in the central region 22a is observed in both the end regions 23a and 123a in the positive direction of the Z-axis and the end regions 24a and 124a in the negative direction of the Z-axis; however, multilayer ceramic capacitors according to the present disclosure are not construed as limited only to such a form. FIG. 5 is a sectional view of a multilayer ceramic capacitor 210 according to a second modified example, illustrating an element body 20 and insulating layers 12 and 13 in a predetermined section of the element body 20 cut in parallel to the first axis (X-axis) and the third axis (Z-axis).

As illustrated in FIG. 5, the multilayer ceramic capacitor 210 is different from the multilayer ceramic capacitor 10 illustrated in the embodiment in that internal electrode layers 36, 37, 38, 39a, and 39b have small widths along the first axis (X-axis) direction only in an end region 223a containing an end 223 of an interior region 21 in the positive direction of the Z-axis. Also, a central region 222a containing a center 22 of the interior region 21 of the multilayer ceramic capacitor 210 continues from the center 22 to an end 224 of the interior region 21 in the negative direction of the Z-axis.

Similarly to the multilayer ceramic capacitor 10 illustrated in FIG. 3, internal electrode layers 35 included in the central region 222a of the multilayer ceramic capacitor 210 have a substantially constant width W1 along the first axis (X-axis) direction. That is, distances between ends, in the negative direction of the X-axis, of the internal electrode layers 35 included in the central region 222a and the insulating layer 12, which extends substantially parallel to the Z-axis direction, have a 1-μm variation at most. Distances between ends, in the positive direction of the X-axis, of the internal electrode layers 35 included in the central region 222a and the insulating layer 13, which extends substantially parallel to the Z-axis direction, have a 1-μm variation at most.

In the multilayer ceramic capacitor 210 as well, at least one of the internal electrode layers 36, 37, 38, 39a, and 39b included in the end region 223a has a width, along the first axis (X-axis) direction, smaller by 1 μm or more than the average value of the width, along the first axis (X-axis) direction, of the internal electrode layers 35 included in the central region 222a. More specifically, the internal electrode layers 36, 37, 38, 39a, and 39b included in the end region 223a are smaller by 0 to 20 μm than the average value of the width W1, along the first axis direction, of the internal electrode layers 35 included in the central region 222a.

As illustrated in FIG. 5, it may be that the internal electrode layers 36, 37, 38, 39a, and 39b with a small width along the first axis (X-axis) direction are disposed only in the end 223 side (in the positive direction of the Z-axis). Such a multilayer ceramic capacitor 210 can particularly suitably prevent a short circuit in a situation where, for example, an exterior region 26 in the negative direction of the Z-axis is thicker than an exterior region 26 in the positive direction of the Z-axis. What is common to the multilayer ceramic capacitors 210 and 10 as well exhibits similar effects brought by the multilayer ceramic capacitor 10.

As illustrated in FIG. 3, the multilayer ceramic capacitor 10 includes a filler 18, which fills spaces between the insulating layers 12 and 13 and electrode layer ends 36a, 37a, 38a, which are ends, in the first axis direction, of the internal electrode layers 36, 37, and 38 included in the end regions 23a and 24a. The filler 18 is not limited. Examples of main constituent materials of the filler 18 include the inner dielectric layers 25 of the element body 20 and a constituent insulating material of the insulating layers 12 and 13.

For example, 90% or more of the composition of the filler 18 in mole percent may match the composition of the insulating layers 12 and 13 or the inner dielectric layers 25. Such a filler 18 can prevent thermal shrinkage behavior of a material near the filler 18, preventing a crack near the end regions 23a and 24a.

Alternatively, for example, 20% or more of the composition of the filler 18 in mole percent may differ from the composition of the insulating layers 12 and 13 or the inner dielectric layers 25. Because there is a conductive material (e.g., the internal electrode layers 36, 37, and 38) near the filler 18, a slight difference in the composition and the thermal shrinkage behavior from the insulating layers 12 and 13 or the inner dielectric layers 25 can mitigate stress concentration, preventing a crack near the end regions 23a and 24a.

Alternatively, for example, the filler 18 may contain at least one selected from the group consisting of Mg, Si, and Mn, and the filler's content of the at least one selected from the group consisting of Mg, Si, and Mn may be higher by 0.01 to 3 mol % than that of the inner dielectric layers 25. With such a filler 18, crystal grain boundaries included in the filler 18 can improve adhesion between the inner dielectric layers 25 and the filler 18.

Alternatively, for example, the filler 18 may contain at least one selected from the group consisting of Mg, Si, and Mn and may contain an oxide of a metal identical to a metal contained in the internal electrode layers 30 (in particular, the internal electrode layers 36, 37, and 38). Such a filler 18 has an effect of oxidizing part of the internal electrode layers 36, 37, and 38 in contact with the filler 18, enabling improvement in adhesion between the filler 18 and the internal electrode layers 36, 37, and 38.

Note that the multilayer ceramic capacitor 10 may include no filler 18 illustrated in FIG. 3. In this situation, between the electrode layer ends 36a, 37a, 38a and the insulating layers 12 and 13 is a pore.

In the multilayer ceramic capacitor 10 illustrated in FIGS. 1 to 3, the inner dielectric layers 25 or the outer dielectric layers 27 of the element body 20 may contain any constituent material. The material contains, for example, a dielectric material with a perovskite structure (e.g., ABO₃) or niobium oxide alkaline ceramic as a main component.

In ABO₃, for example, A includes at least one of Ca, Ba, Sr, and the like whereas B includes at least one of Ti, Zr, and the like. The molar ratio of A/B is not limited and is 0.980 to 1.020.

Other than the above, subcomponents may include silicon dioxide, aluminum oxide, alkaline earth metal compounds (e.g., magnesium oxide), manganese oxide, rare earth element oxide, and vanadium oxide but are not limited thereto. Their content is appropriately determined according to the composition or the like.

The internal electrode layers 30 (including the internal electrode layers 36 to 38, 39a, and 39b) illustrated in FIG. 1 may contain any conductive material. Metals, such as Ni, Cu, Ag, Pd, Al, and Pt, or their alloys can be used. Preferred as a Ni alloy is an alloy of Ni and at least one selected from the group consisting of Mn, Cr, Co, and Al. This alloy has a Ni content of preferably 95 wt % or more. Ni or the Ni alloy may contain approximately 0.1 wt % or less various trace components, such as P.

To form the internal electrode layers 30, a commercially available electrode paste may be used. The thickness of the internal electrode layers 30 is appropriately determined according to a use or the like.

The insulating layers 12 and 13 can contain, for example, a dielectric material with a perovskite structure (e.g., ABO₃) or niobium oxide alkaline ceramic as a main component, similarly to the inner dielectric layers 25 of the element body 20.

Alternatively, the insulating layers 12 and 13 may contain glass as a main component.

Being composed of a glass component enables the insulating layers 12 and 13 to have high bonding strength. It is assumed that this is because formation of a reaction phase at an interface between the glass and the element body 20 makes adhesion between the glass and the element body 20 superior to adhesion between other insulating materials and the element body 20.

The external electrodes 14 and 16 illustrated in FIG. 1 contain a known conductive material (e.g., Cu, Ni, Ag, Pd, Pt, Au, their alloys, and conductive resin). The thickness of the external electrodes 14 and 16 is appropriately determined according to a use or the like.

In FIG. 1, the X-axis, the Y-axis, and the Z-axis are perpendicular to each other, and the Z-axis corresponds to the lamination direction of the inner dielectric layers 25 and the internal electrode layers 30.

The shape or the size of the element body 20 is appropriately determined according to a purpose or a use. Preferred are a width of 0.1 mm to 1.6 mm in the X-axis direction, a length of 0.2 mm to 3.2 mm in the Y-axis direction, and a height of 0.1 mm to 1.6 mm in the Z-axis direction.

Method of manufacturing multilayer ceramic capacitor 10

A method of manufacturing the multilayer ceramic capacitor 10 as one embodiment of the present invention is specifically described next.

First, a first green chip 320 as a green laminate illustrated in FIG. 6 is prepared. The first green chip 320 illustrated in FIG. 6 is prepared by laminating and then cutting inner dielectric green sheets 325 and internal electrode pattern layers 330 between outer dielectric green sheets 327 in pairs. In the first green chip 320, between green exterior regions defined by the outer dielectric green sheets 327 in pairs, a green interior region 321 is disposed, where the inner dielectric green sheets 325 and the internal electrode pattern layers 330 are alternately laminated. The internal electrode pattern layers 330 are portions to become the internal electrode layers 30 after firing. The inner dielectric green sheets 325 are portions to become the inner dielectric layers 25 after firing.

The inner dielectric green sheets 325 and the outer dielectric green sheets 327 are prepared using an organic solvent based paste that results from kneading a ceramic powder and an organic vehicle or using a water based paste. The internal electrode pattern layers 330 are prepared using an internal electrode layer paste that results from kneading a conductive material containing a conductive metal or alloy and an organic vehicle.

Note that, as illustrated in FIG. 6, at laminate side surfaces 320a and 320b of the first green chip 320, side edges of the internal electrode pattern layers 330 are exposed. The side edges constitute both ends of the internal electrode pattern layers 330 in the X-axis direction.

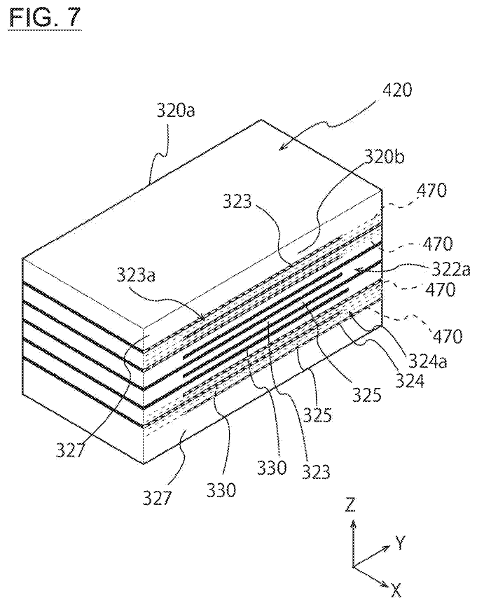

Then, the laminate side surfaces 320a and 320b, which include at least one cut surface of the first green chip 320 illustrated in FIG. 6 (in the example illustrated in FIG. 6, a pair of surfaces facing each other), are irradiated with a laser for laser processing of the green interior region 321. More specifically, the laminate side surfaces 320a and 320b are irradiated with a laser beam along the Y-axis direction, in which the internal electrode pattern layers 330 extend, to partially remove the internal electrode pattern layers 330 exposed to the laminate side surfaces 320a and 320b to form grooves 470. This provides a second green chip 420 illustrated in FIG. 7.

In a laser processing step of forming the grooves 470 illustrated in FIG. 7, the green interior region 321 is laser processed so that the widths, along a normal direction (X-axis direction) of the laminate side surfaces 320a and 320b, of the internal electrode pattern layers 330 included in end regions 323a and 324a containing ends 323 and 324 of the green interior region 321 in the lamination direction (Z-axis direction) are smaller than the width, along the normal direction of the laminate side surfaces 320a and 320b, of the internal electrode pattern layers 330 included in a central region 322a containing a center 322 of the green interior region 321 in the lamination direction. That is, through the laser processing step, while in a state of the green laminate before being fired, a difference in the widths of the internal electrode pattern layers 330 (internal electrode layers 35 to 38) along the X-axis direction is generated. The difference is similar to that of the element body 20 after firing illustrated in FIG. 3. In the laser processing step, controlling the laser irradiation intensity or the irradiation location can remove the internal electrode pattern layers 330 at the laminate side surfaces 320a and 320b with higher priority than the outer dielectric green sheets 327.

Then, the grooves 470 of the laminate side surfaces 320a and 320b of the second green chip 420 illustrated in FIG. 7 are filled with a filling material that becomes the filler 18 after firing. This provides a third green chip before firing. Similarly to the filler 18 of the element body 20 after firing in FIG. 3, the filling material fills portions of the side surfaces of the third green chip where the internal electrode pattern layers 330 have been removed by laser processing. The filling material fills the portions through, for example, impregnation, via the grooves 470. In a situation where the filler 18 is unnecessary, the filling material filling step is unnecessary.

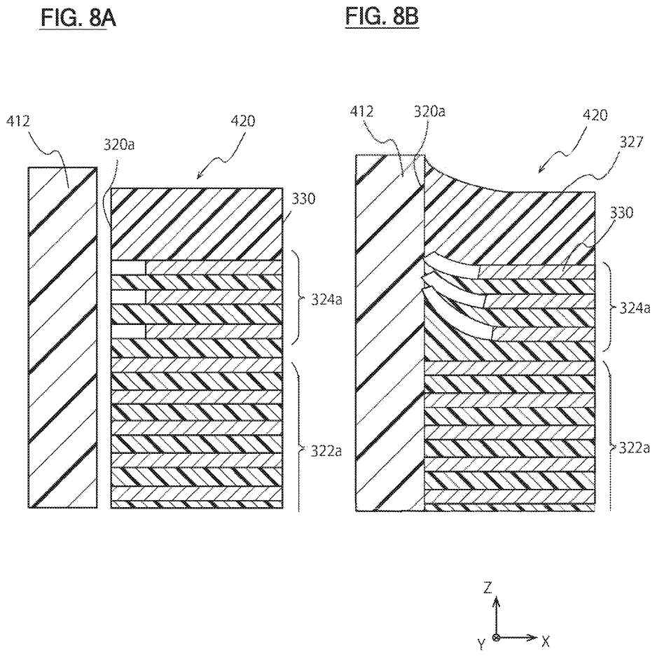

Then, to both side surfaces of the second green chip 420 illustrated in FIG. 7 or the third green chip, the insulating material layers 412, which become the insulating layers 12 and 13 after firing, are transferred, are adhered with pressure, or the like (see FIG. 8). Then, this is solidified and fired to provide the element body 20 having the insulating layers 12 and 13 at the side surfaces 20a and 20b as illustrated in FIGS. 2 and 3.

FIG. 8 is a schematic view of a step of adhesion of the insulating material layer 412 to the laminate side surface 320a of the second green chip 420. FIG. 8(A) illustrates the second green chip 420 and the insulating material layer 412 before adhesion. FIG. 8(B) illustrates the second green chip 420 and the insulating material layer 412 after adhesion.

As is understandable from comparison between FIGS. 8(A) and 8(B), in the step of adhesion of the insulating material layer 412, being pushed from the laminate side surface 320a of the second green chip 420 may cause deformation near the end region 324a of the second green chip 420. It is understandable that a short circuit may occur between the internal electrode pattern layers 330 if, without the laser processing step taken place, deformation of the end region 324a illustrated in FIG. 8(B) leaves the internal electrode pattern layers 330 exposed to the laminate side surfaces 320a and 320b as in the central region 322a.

In contrast, it is understandable that partial removal of the internal electrode pattern layers 330 exposed to the laminate side surfaces 320a and 320b through the laser processing step on the end region 324a as illustrated in FIGS. 7, 8(A), and 8(B) can prevent a short circuit accompanying deformation of the second green chip 420. Note that shape characteristics illustrated in FIG. 8(B) have an effect of preventing a short circuit accompanying deformation in thermal shrinkage during firing similarly to having the effect of preventing a short circuit accompanying deformation in the adhesion step.

Finally, the end surfaces 20c and 20d of the element body 20 are provided with the external electrodes 14 and 16. This provides the multilayer ceramic capacitor 10 illustrated in FIG. 1 and the like. The external electrodes 14 and 16 are formed on the end surfaces 20c and 20d of the element body 20 through, for example, baking of a conductive material, electrolytic plating, or electroless plating.

As described above, according to the multilayer ceramic capacitor 10 illustrated in the embodiment, the widths of the internal electrode layers 36 to 38 along the first axis (X-axis) direction in the end regions 23a and 24a of the interior region 21 are smaller than the width of the internal electrode layers 35 in the central region 22a. In the regions of the element body 20 relatively prone to have deformation due to thermal shrinkage, the internal electrode layers are partially removed or account for a smaller proportion. Thus, according to such a multilayer ceramic capacitor 10, a short circuit between the internal electrode layers 36 to 38 in the vicinity of the side surfaces 20a and 20b opposing the insulating layers 12 and 13 can be appropriately prevented despite deformation of the multilayer ceramic capacitor during or after its manufacture.

### EXAMPLES

Hereinafter, the present disclosure is described based on further detailed examples. However, the present disclosure is not construed as limited to the following examples.

### Example 1

Using the method of manufacturing a multilayer ceramic capacitor described in the description of the embodiment, one thousand multilayer ceramic capacitor samples 110 according to Example 1 with a sectional shape illustrated in the first modified example (FIG. 4) were manufactured. Using these samples, the joining state of insulating layers and the short circuit rate were evaluated.

Conditions of Example 1 were as follows.
Chip size: 0603chip
Capacitance (standard value): 1 μF
Distance between internal electrode layer 36 in end region and insulating layer 12: 0.5 μm
Difference (W1−W2) in widths of internal electrodes along X-axis direction between central region and end region: 1.0 μm
Joining state of insulating material layer 412: Strong adhesion
Filler 18: None

Together with the joining state of the insulating layers 12 and 13, that the distance between the internal electrode layer 36 and the insulating layer 12 and the difference (W1−W2) between the widths of the internal electrodes along X-axis direction were as intended was confirmed by exposing each portion through polishing or the like and observing it with a laser microscope (VK-X1000 manufactured by KEYENCE CORPORATION). Table 1 shows sample conditions and evaluation results of Example 1, as well as other Examples and Comparative Examples.

TABLE 1

| | Sample conditions | | | | |
|---|---|---|---|---|---|
| | | Difference from | | | |
| | Distance between | average width of | Adhesion | Evaluation | |
| | internal electrode | internal electrodes in | condition | Joining | Short |
| | layer and | central region along | of insulating | state of | circuit |
| | insulating layer | X-axis direction | material | insulating | rate |
| | [μm] | [μm] | layer | layer | [%] |
| Example 1 | 0.5 | 1.0 | Strong adhesion | Good | 20 |
| Example 2 | 0.8 | 1.6 | Strong adhesion | Good | 15 |
| Example 3 | 1.4 | 2.8 | Strong adhesion | Good | 7 |
| Example 4 | 2.1 | 4.2 | Strong adhesion | Good | 1 |
| Example 5 | 3.1 | 6.2 | Strong adhesion | Good | 12 |
| Example 6 | 3.6 | 7.2 | Strong adhesion | Good | 13 |
| Example 7 | 4.2 | 8.4 | Strong adhesion | Good | 15 |
| Example 8 | 4.9 | 9.8 | Strong adhesion | Good | 16 |
| Example 9 | 7.2 | 14.4 | Strong adhesion | Good | 18 |
| Example 10 | 9.8 | 19.6 | Strong adhesion | Good | 25 |
| Comparative | 0.0 | 0.0 | Strong adhesion | Good | 25 |
| Example 1 | | | | | |
| Comparative | 0.0 | 0.0 | Weak adhesion | Poor | 61 |
| Example 2 | | | | | |

### Examples 2 to 10

Manufacture of samples and their evaluation were conducted as in Example 1 except that, among the sample conditions, the distance between the internal electrode layer 36 and the insulating layer 12 was changed to 0.8 μm, 1.4 μm, 2.1 μm, 3.1 μm, 3.6 μm, 4.2 μm, 4.9 μm, 7.2 μm, or 9.8 μm and that the difference (W1−W2) in the widths of the internal electrodes along the X-axis direction between the central region and the end region was changed to 1.6 μm, 2.8 μm, 4.2 μm, 6.2 μm, 7.2 μm, 8.4 μm, 9.8 μm, 14.4 μm, or 19.6 μm.

### Comparative Example 1

Manufacture of samples and their evaluation were conducted as in Example 1 except that, among the sample conditions, the distance between the internal electrode layer 36 and the insulating layer 12 was changed to 0.0 μm and that the difference (W1−W2) in the widths of the internal electrodes along the X-axis direction between the central region and the end region was changed to 0.0 μm. Note that, in Comparative Example 1, the laser processing step was omitted during the manufacture of the samples.

### Comparative Example 2

Manufacture of samples and their evaluation were conducted as in Example 1 except that, among the sample conditions, the distance between the internal electrode layer 36 and the insulating layer 12 was changed to 0.0 μm, that the difference (W1−W2) in the widths of the internal electrodes along the X-axis direction between the central region and the end region was changed to 0.0 μm, and that the adhesion of the insulating layers was changed to weak adhesion. Note that, in Comparative Example 2, the laser processing step was omitted during the manufacture of the samples.

In Examples 1 to 10, all samples had a good joining state of the insulating layers and had a short circuit rate of 25% or less, providing good evaluation results. In particular, in Examples 2 to 7, a significant reduction in the short circuit rate was confirmed, in comparison with Comparative Examples 1 and 2.

### REFERENCE NUMERALS

10, 110, 210 . . . multilayer ceramic capacitor
20 . . . element body
20a, 20b, 320a, 320b . . . side surface
20c, 20d . . . end surface
21, 321 . . . interior region
22, 322 . . . center
22a, 222a, 322a . . . central region
23, 24, 123, 124, 223, 224, 323, 324 . . . end
23a, 24a, 123a, 124a, 223a, 323a, 324a . . . end region
25 . . . inner dielectric layer
26 . . . exterior region
27 . . . outer dielectric layer
30, 35, 36, 37, 38, 39a, 39b, 136, 137, 138 . . . internal electrode layer
30a . . . first internal electrode layer
30b . . . second internal electrode layer
31 . . . internal electrode lead-out portion
34 . . . internal electrode overlapping portion
36a, 37a, 38a . . . electrode layer end
12, 13 . . . insulating layer
14, 16 . . . external electrode
18 . . . filler
W1, W2, W3, W4 . . . width
320 . . . first green chip
321 . . . green interior region
325 . . . inner dielectric green sheet
327 . . . outer dielectric green sheet
330 . . . internal electrode pattern layer
420 . . . second green chip
470 . . . groove
412 . . . insulating material layer

What is claimed is:

1. A multilayer electronic device comprising:
an element body comprising internal electrode layers and dielectric layers, the internal electrode layers and the dielectric layers being alternately laminated along a direction of a third axis and being substantially parallel to a plane containing a first axis and a second axis,
wherein
the element body comprises side surfaces in pairs each being provided with an insulating layer, the side surfaces facing each other in a direction of the first axis;
the element body comprises end surfaces in pairs each being provided with an external electrode electrically connected to the internal electrode layers, the end surfaces facing each other in a direction of the second axis;
the internal electrode layers comprise first internal electrode layers and second internal electrode layers;
the first internal electrode layers connect to the external electrode on one of the end surfaces in pairs;
the second internal electrode layers connect to the external electrode on an other one of the end surfaces in pairs;
the internal electrode layers comprise an internal electrode overlapping portion and an internal electrode lead-out portion;
the internal electrode overlapping portion is where the first internal electrode layers and the second internal electrode layers overlap when viewed from the direction of the third axis;
the internal electrode lead-out portion is where the first internal electrode layers and the second internal electrode layers do not overlap when viewed from the direction of the third axis;
the internal electrode lead-out portion comprises a lead-out portion side edge at either end in the direction of the first axis;
the internal electrode overlapping portion comprises an overlapping portion side edge at either end in the direction of the first axis;
the overlapping portion side edge comprises an overlapping portion side edge central part at a center in the direction of the second axis; and
at least one of the internal electrode layers has larger irregularities along the direction of the second axis at the lead-out portion side edge than at the overlapping portion side edge central part.

2. The multilayer electronic device according to claim 1, wherein, in the at least one of the internal electrode layers,
a length along the direction of the first axis between the insulating layer and the lead-out portion side edge or the overlapping portion side edge is defined as a depth of the lead-out portion side edge or the overlapping portion side edge;
the lead-out portion side edge has lead-out portion side edge depressions each having a largest depth between two second-axially adjacent points at an average depth of the lead-out portion side edge;
the lead-out portion side edge depressions have an average depth of 0.2 to 10 μm;
the overlapping portion side edge central part has central part side edge depressions each having a largest depth between two second-axially adjacent points at an average depth of the overlapping portion side edge central part;
the central part side edge depressions have an average depth of 0 to 2 μm; and
the average depth of the lead-out portion side edge depressions is larger than the average depth of the central part side edge depressions.

3. The multilayer electronic device according to claim 1, wherein
a length along the direction of the first axis between the insulating layer and the lead-out portion side edge or the overlapping portion side edge is defined as a depth of the lead-out portion side edge or the overlapping portion side edge;
the lead-out portion side edge has lead-out portion side edge depressions each having a largest depth between two second-axially adjacent points at an average depth of the lead-out portion side edge; and
the at least one of the internal electrode layers has a (A-B1-B2)/A of 0.9 or more, where
“A” denotes a maximum width of the internal electrode lead-out portion along the direction of the first axis,
“B1” denotes an average depth of the lead-out portion side edge depressions of the lead-out portion side edge at one side in the direction of the first axis, and
“B2” denotes an average depth of the lead-out portion side edge depressions of the lead-out portion side edge at an other side in the direction of the first axis.

4. The multilayer electronic device according to claim 3, wherein both B1 and B2 are 0.2 to 10 μm.

5. The multilayer electronic device according to claim 1, wherein
a length along the direction of the first axis between the insulating layer and the lead-out portion side edge or the overlapping portion side edge is defined as a depth of the lead-out portion side edge or the overlapping portion side edge;
in the at least one of the internal electrode layers,
the overlapping portion side edge central part has a maximum depth not exceeding 50% of that of the lead-out portion side edge;
the overlapping portion side edge comprises an overlapping portion side edge uneven part having a maximum depth exceeding 50% of that of the lead-out portion side edge;
the overlapping portion side edge comprises the overlapping portion side edge central part and the overlapping portion side edge uneven part; and
the overlapping portion side edge uneven part comprises overlapping portion side edge uneven parts in pairs disposed at both sides of the overlapping portion side edge central part in the direction of the second axis.

6. The multilayer electronic device according to claim 5, wherein
a length of the overlapping portion side edge central part along the direction of the second axis is 40% to 90% of an entire length of the at least one of the internal electrode layers along the direction of the second axis; and
a sum of lengths of the overlapping portion side edge uneven part and the lead-out portion side edge along the direction of the second axis is 10% to 60% of the entire length of the at least one of the internal electrode layers along the direction of the second axis.

7. The multilayer electronic device according to claim 5, wherein a sum of lengths of the overlapping portion side edge uneven part and the lead-out portion side edge of the at least one of the internal electrode layers along the direction of the second axis is 40 to 100 μm.

8. The multilayer electronic device according to claim 1, wherein
the lead-out portion side edge has a surface roughness Ra of 100 to 1000 nm along the direction of the second axis; and
the overlapping portion side edge central part has a surface roughness Ra being smaller than that of the lead-out portion side edge and being 10 to 200 nm along the direction of the second axis.

9. The multilayer electronic device according to claim 1, comprising a filler at least partly filling the irregularities of the lead-out portion side edge between the side surfaces of the element body and the insulating layer.

10. The multilayer electronic device according to claim 9, wherein 90% or more of a composition of the filler in mole percent matches a composition of the insulating layer or the dielectric layers.

11. The multilayer electronic device according to claim 9, wherein 20% or more of a composition of the filler in mole percent differs from a composition of the insulating layer or the dielectric layers.

12. The multilayer electronic device according to claim 9, wherein
the filler comprises at least one selected from the group consisting of Mg, Si, and Mn; and
a content of the at least one selected from the group consisting of Mg, Si, and Mn is higher by 0.01 to 3 mol % than that of the dielectric layers.

13. The multilayer electronic device according to claim 9, wherein
the filler comprises at least one selected from the group consisting of Mg, Si, and Mn; and
the filler comprises an oxide of a metal identical to a metal contained in the internal electrode layers.
